(19) United States
(12) Patent Application Publication
(10) Pub. No.: US 2003/0071962 A1
(43) Pub. Date: Apr. 17, 2003

(54) Lens mounting arrangement for eyeglasses, and method of mounting eyeglass lens

(76) Inventor: Iwao Nishihara, Hyogo-Ken (JP)

Correspondence Address: LEVINE & MANDELBAUM, 350 FIFTH AVENUE SUITE 7814, EMPIRE STATE BUILDING, NEW YORK, NY, 10118, US

(21) Appl. No.: 10/272,420

(22) Filed: Oct. 16, 2002

(30) Foreign Application Priority Data
Oct. 16, 2001 (JP) 2001-317991
Nov. 9, 2001 (JP) 2001-344205

(51) Int. Cl. G02C 1/02

(52) U.S. Cl. 351/110

(57) ABSTRACT

A lens mounting arrangement for eyeglasses includes an eyeglass frame component, an externally threaded stud projecting from the component, an eyeglass lens having a hole large enough to loosely accommodate the stud, and a plastic nut cooperable with the stud for securing the lens to the frame component. The nut has an axial bore including a side wall which is initially smooth and unthreaded. The diameter of the bore is such that as the nut is turned on to the stud, the threads of the stud produce a corresponding internal thread in the side wall of the bore. As a result, the interengagement of the threads of the stud and nut secure the lens to the frame component. The nut comprises a tubular body and an enlarged head at one end of the body, the head becoming seated against the lens so that the lens, when mounted, is sandwiched between the frame component and the head of the nut. The tubular body of the nut is initially longer than the thickness of the lens, and prior to turning the nut onto the stud, the tubular body is cut to a length no longer than the thickness of the lens.

This invention relates to eyeglasses, and more particularly, to the means for mounting eyeglass lenses to an eyeglass frame.

Many eyeglass frames are provided with two lens openings each being completely surrounded by the wire of which the lens is made. In such frames, each lens is snapped into its respective opening and the tight fit of the wire completely encircling the lens secures the lens to the frame.

However, some frames, for stylistic reasons, do not include lens openings completely surrounded by the wire of which the frame is made. Instead, the frames are “rimless”, and the lenses are attached, by fasteners, to individual frame components. In such “rimless” eyeglasses, it is common to drill holes in a lens and make the attachment by means of a screw passing through the hole in the lens and a nut threaded on to the screw. In other arrangements, an externally threaded stud projects from the frame component, and a cooperable internally threaded nut holds the lens to the frame component. It is also known to use a stud formed with ribs on its outer surface, a plastic tube or sleeve being forced on to the ribbed stud to hold the lens in place.

Each of these known arrangements has its disadvantages. Metal screws and nuts can crack a plastic lens if screwed together too tightly. The plastic tube or sleeve “force fit” over a ribbed stud cannot readily be removed when the lens is to be replaced.

It is an object of the present invention to overcome these problems by providing a lens mounting arrangement for eyeglasses wherein a non-metal, preferably plastic, attachment element is used which firmly secures a lens to a frame component, but which nevertheless can readily be separated so as to permit replacement of the mounted lens.

It is another object of the invention to provide such a mounting arrangement employing a metal threaded stud and a plastic nut cooperable with the stud, the nut being formed with an axial bore having a smooth wall such that when the nut is turned onto the stud, the threads of the stud produce internal threads in the nut bore. This “self-tapping” arrangement provides for a solid attachment between nut and stud, and yet permits the nut to be readily unscrewed off the stud so as to conveniently permit lens replacement.

Another object of the invention is to provide such a mounting arrangement wherein threaded tubular nuts of excess length are provided, the nuts being cut to size appropriate for the thickness of the lens being mounted.

Additional objects and features of the invention will be apparent from the following description, in which reference is made to the accompanying drawings.

In the drawings:

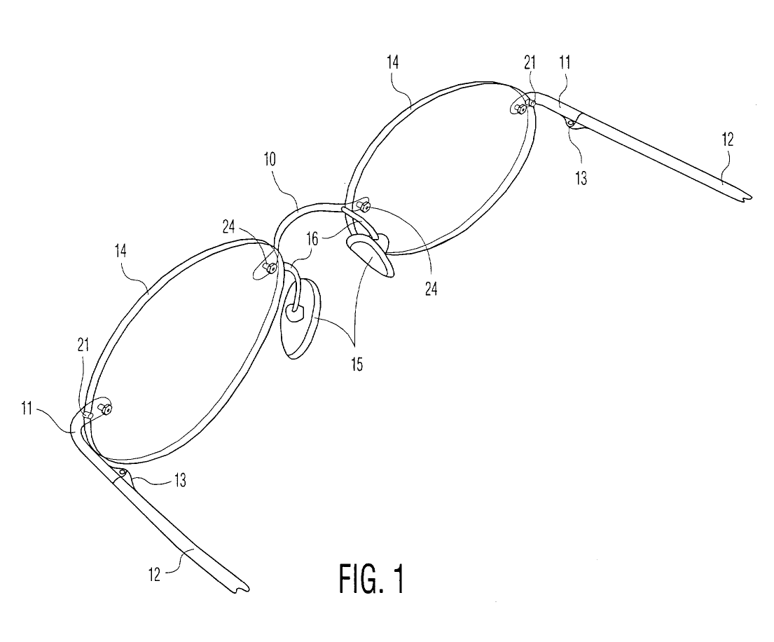

FIG. 1 is a prospective view of eyeglass frame components and lenses incorporating the mounting arrangement of the present invention;

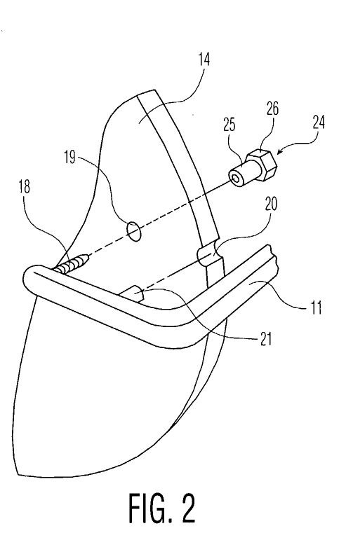

FIG. 2 is a fragmentary, exploded, perspective view of a part of the mounting arrangement;

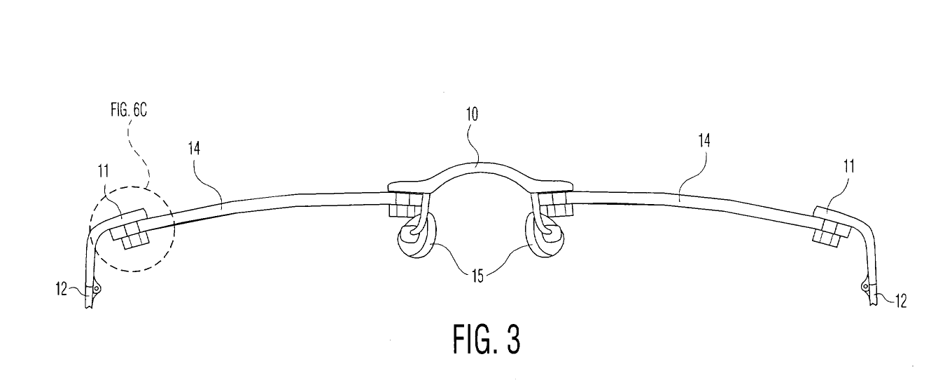

FIG. 3 is a fragmentary top plan view of the eyeglasses shown in FIG. 1;

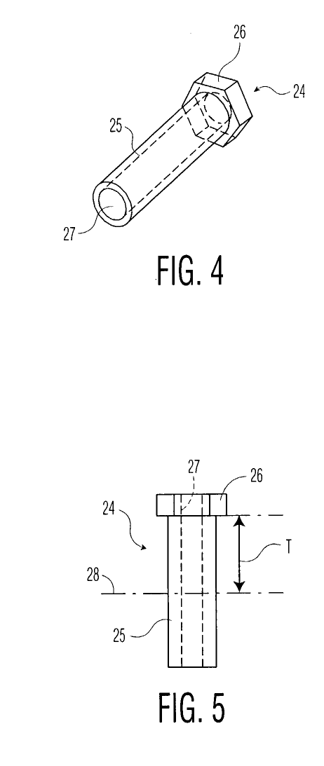

FIG. 4 is a perspective view of a nut according to the present invention;

FIG. 5 is an elevational view of the nut;

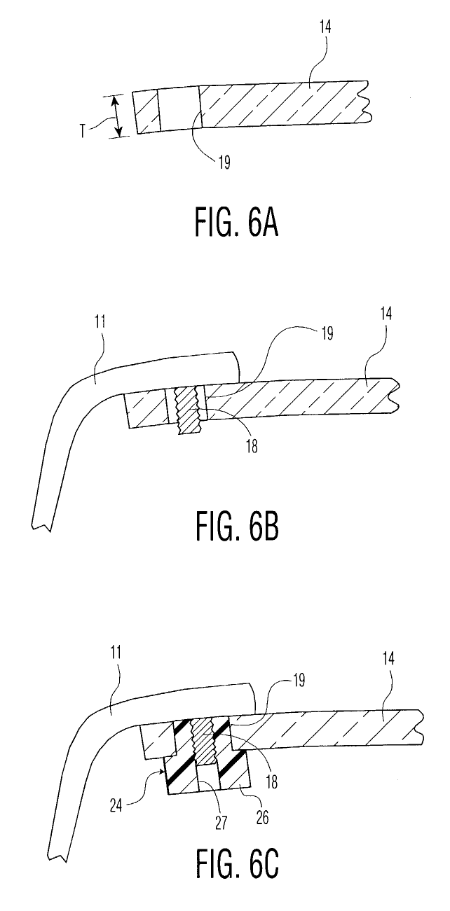

FIGS. 6A-6C are fragmentary, horizontal cross sectional views showing a sequence of steps mounting a lens to a frame component;

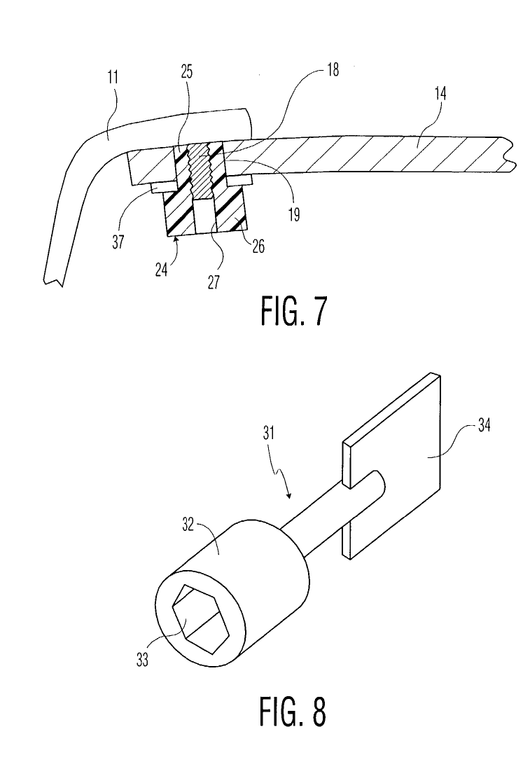

FIG. 7 is a view similar to FIG. 6C showing an alternative embodiment of the mounting; and

FIG. 8 is a prospective view of a wrench for turning the nut on to the stud.

The eyeglasses chosen to illustrate the present invention, and shown in FIGS. 1-3, comprise frame components and two lenses. The frame components include a central nose bridge 10, two generally L-shaped side brackets 11, and two temples 12, hinged at 13 to their respective side brackets 11. Each lens 14 is located between nose bridge 10 and one of the side brackets 11. Nose bridge 10 carries the usual nose pads 15, which rest upon the users nose when the eyeglasses are worn, the pads being supported by wires 16.

Near its end opposite hinge 13, each bracket 11 has projecting from it an externally threaded stud 18 (FIGS. 2 and 6B), and similar externally threaded studs project from nose bridge 10 near each of its ends. Thus, in the present example, a total of four externally threaded studs 18 project from frame components 10 and 11. Each of the lenses 14 is formed with two holes 19 (FIGS. 2 and 6A) near its ends. The diameter of each hole 19 is larger than the diameter of each stud 18. Each lens 14 is also formed with a peripheral notch 20 (FIGS. 1 and 2) adapted to cooperate with a pin 21 projecting from each of the brackets 11, pins 21 being spaced from and parallel to their respective studs 18. Each lens 14 is also formed with another peripheral notch (not shown) each of those notches being cooperable with the wire supports 16 which hold nose pads 15.

For the purpose of securing lenses 14 to frame components 10 and 11, the invention provides nuts 25 cooperable with studs 18. Each nut includes a cylindrical tubular body 25 and an enlarged head 26 at one end of the body 25. The head 26 has a non-circular shape, such as the hexagonal shape shown in the drawings. An axial bore 27 extends for the full length of the nut 24. The inner wall of bore 27 is smooth.

Nut 24 is formed of a suitable plastic material, such as a polycarbonate. The frame components 10, 11, and 12, including studs 18, are formed of a suitable metal. Typically, studs 18 are soldered at one end to their respective frame components. The important point is that studs 18 are formed of a material harder than the material of which nuts 24 are formed, so that studs 18 can perform a “self-tapping” function when nuts 24 are turned on to the studs.

It is desirable for the length of tubular body 25 of the nut to be about equal to, or slightly less than, the thickness of lens 14 at the location of hole 19. However, the thickness of lenses 14 vary, depending upon the amount of vision correction which the lens is to provide. Therefore, the present invention contemplates adjusting the length of the nut tubular body to the particular lens being assembled with a frame component. Specifically, all the nuts are provided with tubular bodies having a length in excess of any length which may be required to mount a lens on a frame component. At the time that a lens and frame component are to be assembled, the thickness T (FIG. 6A) is measured, if not already known in advance. The tubular body 25 of a nut 24 (FIG. 5) is then severed transversally, along line 28, so that the distance T from the cut end of the tubular body to the inner face of head 26 is about equal to or slightly less than the thickness T of lens 14.

When the lens 14 and a frame component, say, component 11, are to be assembled, stud 18 projecting from that component is inserted through hole 19 in the lens (FIG. 6B). Since the diameter of stud 18 is smaller than the diameter of hole 19, an annular space remains around the stud. This space is large enough to accommodate the thickness of the wall of a nut tubular body 25. After the tubular body is cut to appropriate length, the nut 24 is turned on to threaded stud 18. A convenient way of accomplishing this is to use a wrench 31 (FIG. 8), the wrench having a head 32 formed with a hexagonal recess 33 adapted to snugly accommodate head 26 of nut 24. Wrench 31 can readily be rotated by grasping its plate-like tail 34 between the fingers.

As mentioned above, the inner wall of bore 27 in nut 24 is initially smooth, i.e., unthreaded. However, as plastic nut 24 is turned on to metal threaded stud 18 the threads of the stud cut into the plastic of the nut and create an internal screw thread in the wall of bore 27. Nut 24 is tightened on to stud 18 until the inner face of nut head 26 seats against the face of lens 14. In this way, lens 14 is tightly sandwiched between frame component 11 and nut head 26. Should it be necessary, at any time, to replace lens 14, nut 24 can readily be unscrewed from stud 18, the lens replaced, and the same nut or a new nut employed to secure the new lens to the frame component.

When the lens and frame component are assembled as described above, one of the pins 21 or wire pads ports 16 will become engaged within the notch 20 in the peripheral of the lens. This engagement prevents relative rotation between the lens and frame component about the axis of stud 18.

In some cases, it may be desirable to employ a washer 37 (FIG. 7) with nut 24. In such a case, the washer is placed around the tubular body 25 prior to turning the nut on to the stud 18. The washer will compensate for a case where the lens hole 19 is relatively large as compared to the size of nut head 26.

Although the example described above employs a threaded stud fixed to, and projected from, the frame component, the invention also contemplates that a separate screw could be used fitting through a hole in the framed component, the screw then cooperating with a plastic nut 24, as described above.

The invention has been shown and described in preferred form only, and by way of example, and many variations may be made in the invention which will still be comprised within its spirit. It is understood, therefore, that the invention is not limited to any specific form or embodiment except insofar as such limitations are included in the appended claims.

1. A lens mounting arrangement for eyeglasses, comprising:
an eyeglass frame component,
an externally threaded metal stud projecting from the component
a lens having a hole for loosely accommodating the stud, and
a plastic nut cooperable with the stud for securing the lens to the frame component, the nut having an axial bore the side wall of which is initially unthreaded, the diameter of the bore being so sized with respect to the diameter of the stud that as the nut is turned on the stud, the threads of the stud form a corresponding internal thread in the side wall of the bore,
whereby the interengagement of the threads of the stud and nut secure the lens to the frame component.

2. An arrangement as defined in claim 1 wherein the stud is fixed to the frame component.

3. An arrangement as defined in claim 1 wherein the frame component is formed with a hole, and the stud is part of a headed screw, the stud portion of the screw fitting through the hole in the frame component but the head portion of the screw being larger than the diameter of the hole.

4. An arrangement as defined in claim 1 wherein the nut comprises a tubular body, and an enlarged head at one end of the body.

5. An arrangement as defined in claim 4 wherein the enlarged head has a non-circular peripheral shape.

6. An arrangement as defined in claim 4 wherein the hole in the lens is large enough in diameter to accommodate the tubular body of the nut, but not large enough to accommodate the head.

7. An arrangement as defined in claim 6 wherein after the nut is turned on to the stud, the lens is sandwiched between the frame component and the head of the nut.

8. An arrangement as defined in claim 7 including a plastic washer surrounding the tubular body of the nut and located between the lens and the head of the nut.

9. An arrangement as defined in claim 4 wherein the axial length of the tubular body is initially longer than the thickness of the lens.

10. An arrangement as defined in claim 9 wherein the assembled condition of the lens mounting arrangement, the length of the tubular body of the nut is about equal to the thickness of the lens.

11. An arrangement as defined in claim 9 wherein the assembled condition of the lens mounting arrangement, the tubular body of the nut is shorter than the thickness of the lens.

12. An arrangement as defined in claim 1 wherein the nut is formed of a polycarbonate material.

13. A method of mounting an eyeglass lens, having a hole in it, on to an eyeglass frame component, having an externally threaded metal stud projecting from it, comprising the steps of:
providing a plastic nut having an axial bore the side wall of which is initially unthreaded,
inserting the stud though the hole in the lens, and
turning the nut on to the stud so that the threads of the stud form a corresponding internal thread in the side wall of the bore,
whereby the nut and stud are firmly interengaged and thereby secure the lens to the frame component.

14. A method as defined in claim 13 wherein the nut comprises a tubular body and an enlarged head at one end of the body, and the nut is turned on to the stud until the head seats against the lens.

15. An arrangement as defined in claim 14 wherein the tubular body of the nut, as initially provided, has a length greater than the thickness of the lens, and the tubular body is severed transversely to shorten it to a length about equal to or less than the thickness of the lens.
